(19) United States
(12) Patent Application Publication
(10) Pub. No.: US 2013/0033957 A1
(43) Pub. Date: Feb. 7, 2013

(54) Stirrer having Programmable Stirring Mode Control

(71) Applicant: Kun-Chung Huang, Taichung City (TW)

(72) Inventor: Kun-Chung Huang, Taichung City (TW)

(73) Assignee: SPAR FOOD MACHINERY MANUFACTURING CO., LTD., Taichung City (TW)

(21) Appl. No.: 13/198,293

(22) Filed: Aug. 4, 2011

(51) Int. Cl. B01F 13/00

(52) U.S. Cl. 366/206

(57) ABSTRACT

A stirrer having programmable stirring mode control comprises a stirrer main body, an input interface, a controller and a frequency changer. The stirrer main body drives a stirring axle to rotate through a driving mechanism. The controller controls the frequency changer through a vector control circuit so as to control changeable frequency three-phase alternating current voltages or current of a three-phase induction motor. The controller executes stirring steps of multiple set of material items at an automatic mode. Predetermined parameters of the stirring step can be stored after updating, thereby forming the stirrer.

### BACKGROUND OF THE INVENTION

1. Field of the Invention

The present invention relates to a stirrer capable of stirring materials, and more particularly to a stirrer having programmable stirring mode control.

2. Description of the Related Art

As shown in FIG. 15 for a circuit control flow of a conventional stirrer is mainly applied to a stirring operation control of food materials. A user controls mechanical motions of the stirrer through a user interface 90 and parameters setting of stirring time and stirring speed. The operation time and the operation speed of the motor 93 are controlled by a timer 91 and a driver 92 during the stirring. However, the circuit control flow of the conventional stirrer has the following defects.

1. As shown in FIG. 15, a coder 94 is disposed between the driver 92 and the motor 93 to form a closed loop control between the driver 92 and the motor 93. When the driver 92 controls the operation of the motor 93, the motor is also controlled by speed indication of the coder 94. In the meantime, the driver 92 receives a feedback signal of the coder 93 to allow the driver 92 to perform rotating speed compensation for the motor 93. Therefore, the coder 94 is an important component in a conventional circuit control flow. Although the driver 92 obtains the feedback signal to compensate the rotating speed of the motor 93, the coder 94 is still the component increased between the driver 92 and the motor 93. If the coder 94 is malfunction, the motor 93 may be abnormally driven, and the disposition of the coder 94 also causes wire complexity between the driver 92 and the motor 93.

2. The circuit control flow of the conventional stirrer can merely set one set of a combination of stirring time and stirring speeds. Therefore, in the process of stirring food materials, the user does not only remember stirring material and stirring steps of the food material, but also respectively set proper stirring time and stirring speed based upon different stirring speeds. If the user does not remember the stirring time and the stirring speed of related steps or does not remember which step has been performed, the process may cause failure. Consequently, the factor of artificial mistake is usually greater than the control of the stirrer.

### SUMMARY OF THE INVENTION

In view of the shortcomings of the prior art, the inventor(s) of the present invention based on years of experience in the related industry to conduct extensive researches and experiments, and finally developed a stirrer having programmable stirring mode control, as a principle objective, that is disposed between a controller and a three-phase induction motor without using a coder or a motor rotating speed feedback meter so that abnormal problems between the controller and the three-phase induction motor resulted from the coder or the motor rotating speed feedback meter can be prevented. Wires between the controller and the three-phase induction motor can be simplified by leaving out the coder or the motor rotating speed feedback meter.

A second objective of the invention is to provide a stirrer having programmable stirring mode control that utilizes the controller to save formula, stirring steps for different foods and save predetermined parameters such as stirring speeds and stirring time required for different stirring steps, and formula, the stirring steps and the predetermined parameters can be changed through the setting and updated into new parameters. Failure to stir food material caused by artificial mistakes can be reduced to increase the efficiency of the operation in stirring food materials.

To achieve the foregoing objectives, the invention comprises: a stirrer main body having a stand column on a bottom seat of the stirrer main body, a top of the stand column having a head portion, two support arms outwardly stretched from the stand column to combine with a stirring bucket, the head portion having a stirring axle downwardly stretched toward the stirring bucket, a driving mechanism disposed in the head portion to drive the stirring axle to rotate and to simultaneously drive the stirring axle eccentrically circling a center of the stirring bucket, the driving mechanism comprising a three-phase induction motor;

an input interface comprising a plurality of input components and at least one display component;

a controller storing an execution program, the execution program comprising an automatic mode capable of executing stirring steps of multiple sets of material items, predetermined parameters comprising stirring speed and stirring time respectively corresponding to the stirring steps of each material item, the predetermined parameters stored by the controller and displayed by the display component, the input component updating numerical of the predetermined parameters that are stored as new parameters;

a frequency changer connected to and controlled by the controller, the frequency changer comprising a vector control circuit for controlling changeable frequency three-phase alternating current voltages or current of the three-phase induction motor.

### BRIEF DESCRIPTION OF THE DRAWINGS

FIG. 1 is an appearance diagram of a structure of a stirrer according to the invention;

FIG. 2 is a schematic diagram of a configuration of a stirrer having programmable control according to the invention;

FIG. 3 is a flowchart of setting class of material items according to the invention;

FIG. 4 is a schematic diagram of a screen of displaying class of material items according to the invention;

FIG. 5 is a schematic diagram of a screen of displaying subclass of material items according to the invention;

FIG. 6 is a schematic diagram of a screen of displaying stirring information of material items according to the invention;

FIG. 7 is a flowchart of setting stirring steps according to the invention;

FIG. 8 is a schematic diagram of a screen of displaying stirring time and speed associated with stirring steps according to the invention;

FIG. 9 is a schematic diagram of a screen of displaying stirring speed according to the invention;

FIG. 10 is a flowchart of setting formula content according to the invention;

FIG. 11 is a schematic diagram of a screen of displaying formula content according to the invention;

FIG. 12 is a flowchart of an automatic mode according to the invention;

FIG. 13 is a flowchart of an automatic mode according to the invention;

FIG. 14 is a schematic diagram of a screen of displaying manual mode according to the invention; and

FIG. 15 is a circuit control flow of a conventional stirrer.

### DETAILED DESCRIPTION OF THE PREFERRED EMBODIMENTS

The foregoing and other technical characteristics of the present invention will become apparent with the detailed description of the preferred embodiments and the illustration of the related drawings.

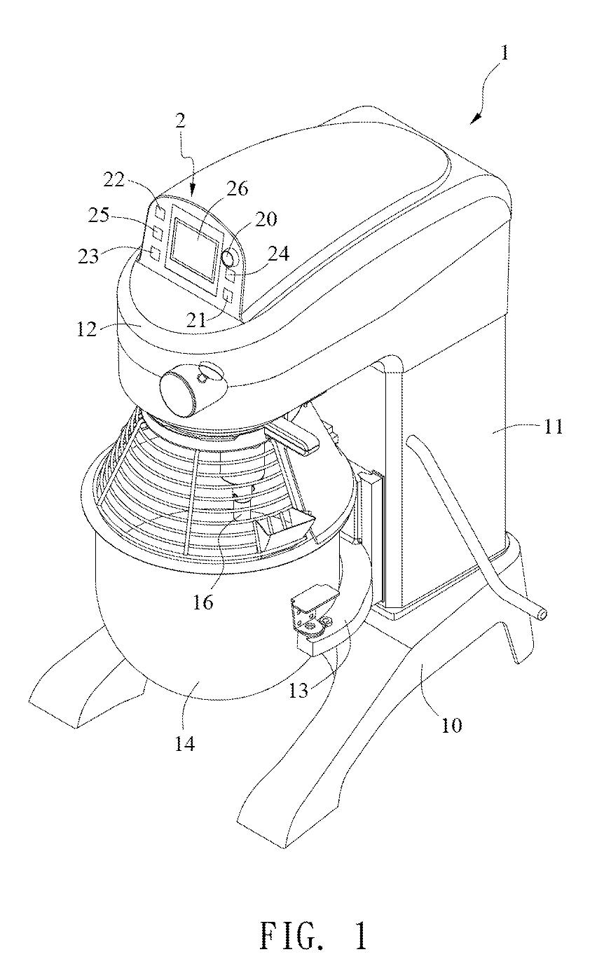

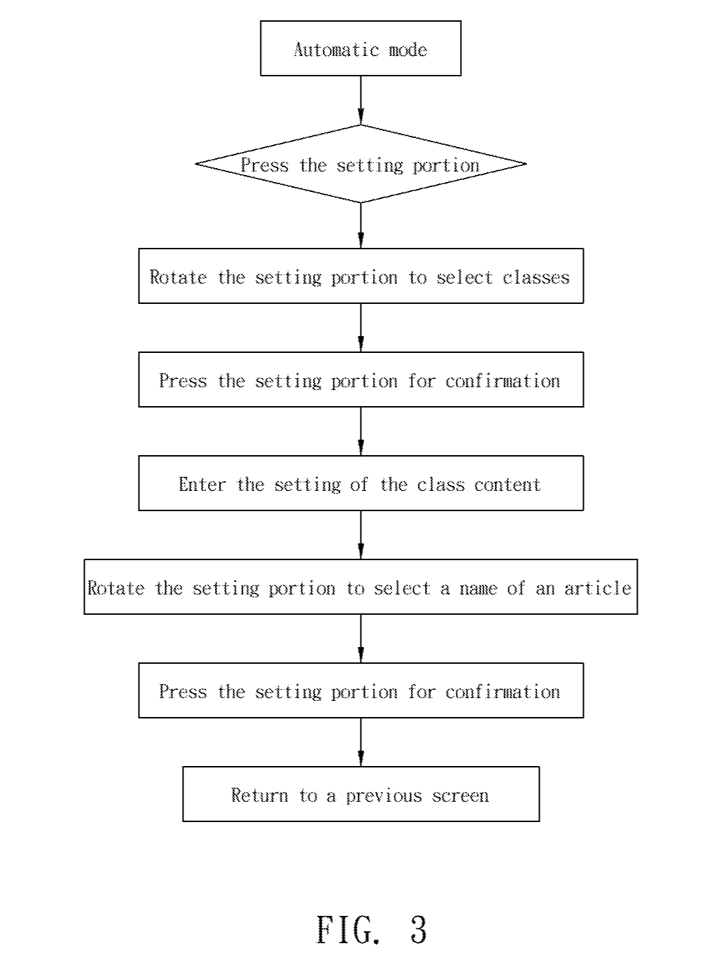

With reference to FIG. 1 to FIG. 5, the embodiment provides a stirrer having programmable stirring mode control. A structure of the stirrer is shown in FIG. 1 and has a stirrer main body 1 having a bottom seat 10, a stand column 11, a head portion 12, two support arms 13 and a stirring bucket 14. The stand column 11 is vertically disposed on the bottom seat 10. The head portion 12 is horizontally disposed on a top of the stand column 11. The two support arms 13 are outwardly stretched out between the bottom seat 10 and the head portion 12 from the stand column 11, and the two support arms 13 are combined with the stirring bucket 14. A driving mechanism is disposed in the head portion 12, and the head portion 12 has a stirring axle 16 downwardly stretching toward the stirring bucket 14. The stirring bucket 16 is driven by the driving mechanism to perform rotation, and the stirring axle 16 is simultaneously driven to eccentrically circle the center of the stirring bucket 14. In another word, the stirring axle 16 circles the center of the stirring bucket 14 to perform revolution. The driving mechanism comprises a three-phase induction motor 15.

The head portion 12 of the stirrer main body 1 is disposed with an input interface 2. The input interface 2, as shown in FIG. 1, comprises a plurality of input components. The input components has a setting portion 20, a start key 21, a stop key 22, a pause key 23, a mode/formula key 24 and a vibration key 25, wherein the setting portion 20 is a flying shuttle knob having a pressing confirmation function. The input interface 2 also has a display component 26.

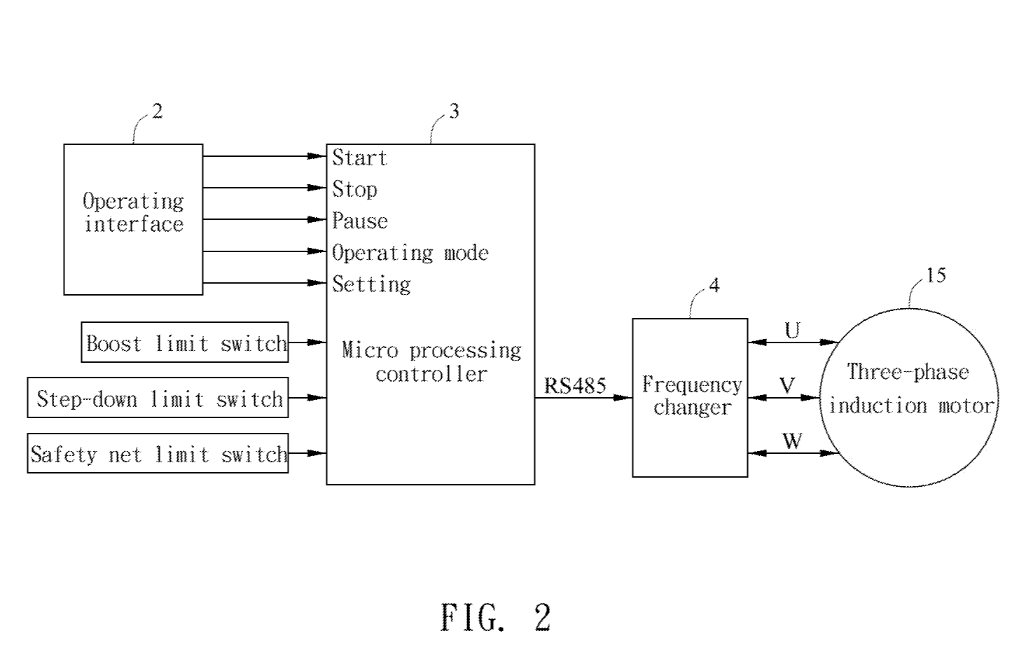

As shown in FIG. 2, a controller 3 is disposed in the stirrer main body 1. An execution program is preset in the controller 3. A frequency changer 4 is also disposed in the stirrer main body 1 and connected to and controlled by the controller. The frequency changer comprises a vector control circuit for controlling the changeable frequency three-phase alternating current voltage or current of the three-phase induction motor 15.

In the embodiment, the execution program can select an automatic mode or a manual mode by pressing the mode/formula key 24. While in the automatic mode, stirring steps of multiple sets of material items can be executed. Predetermined parameters comprise stirring speed and stirring time respectively corresponding to the stirring steps of each material item. The predetermined parameters are saved by the controller 3, and the predetermined parameters can be displayed on the display component 26. Numerical of the predetermined parameters can be updated by the input interface 2 in the embodiment, and new parameters can be stored after updating.

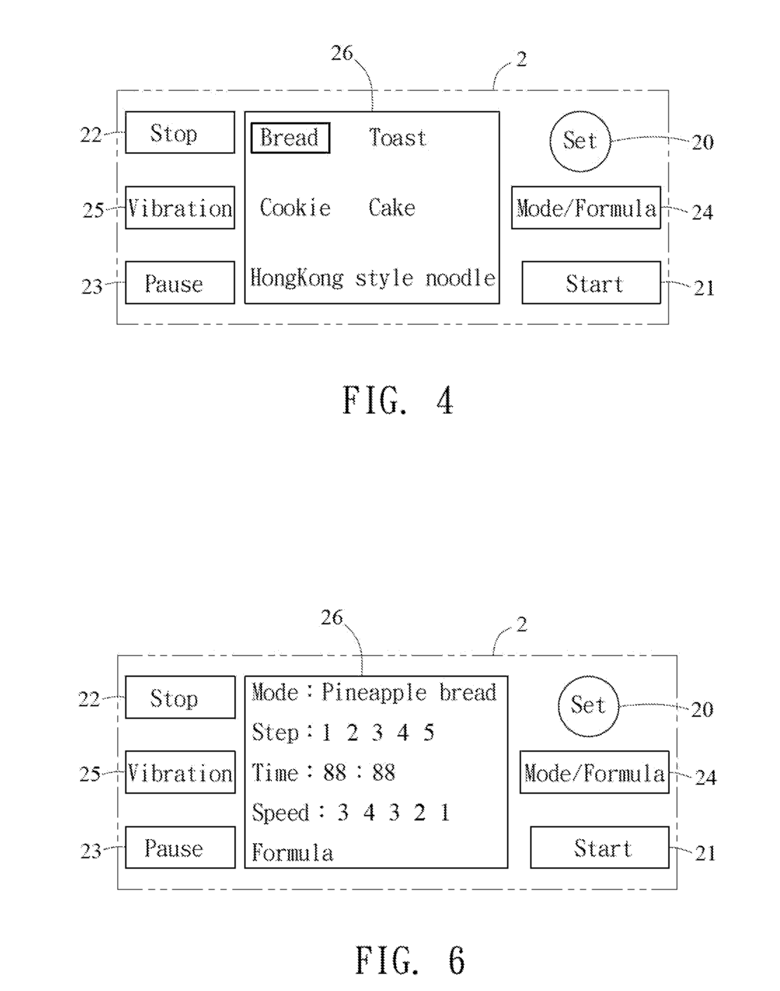

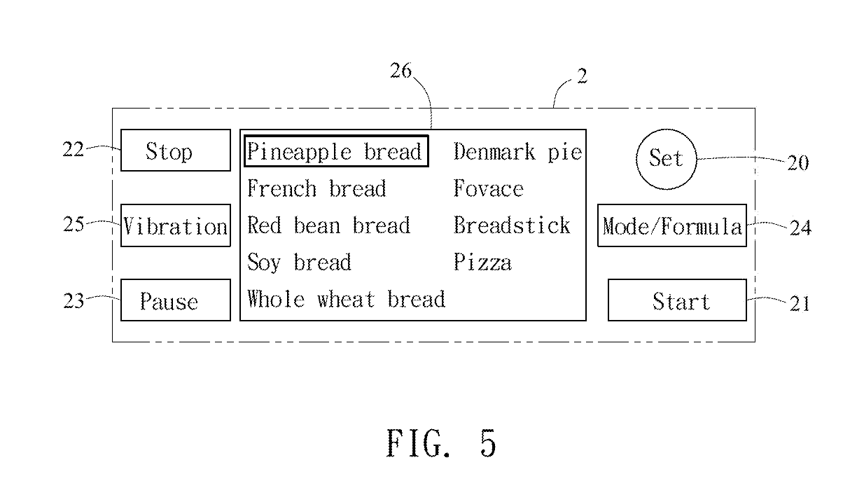

As shown in FIG. 2, to perform the setting flow of setting material item and class, pineapple bread is selected as a stirring material in the embodiment. The setting portion 20 is pressed at the automatic mode. The display component 26 then shows a screen as shown in FIG. 4, including food classes such as bread, toast, cookie, cake and hongkong style noodle. In the meantime, the setting portion 20 is rotated to reach “bread” class, and the setting portion 20 is pressed to complete confirmation, thereby entering a sub-class of “bread”. As shown in FIG. 5, the display component 26 would display the sub-classes such as pineapple bread, Denmark pie, French bread. By rotating the setting portion 20 to reach “pineapple bread”, the setting portion 20 then is pressed to perform confirmation so as to display the screen as shown in FIG. 6. Stirring information of pineapple bread is displayed in FIG. 6 and comprises selections such as material items, stirring steps, stirring time and stirring speed and formula content. Pineapple bread is taken as an example to display the stirring steps of pineapple bread comprises step one to step five, stirring time corresponding to each step, stirring time required for step one to step five, and formula content of pineapple bread. The material items, stirring steps, stirring time, stirring speed and formula content are preset by the controller in the light of material items of pineapple bread.

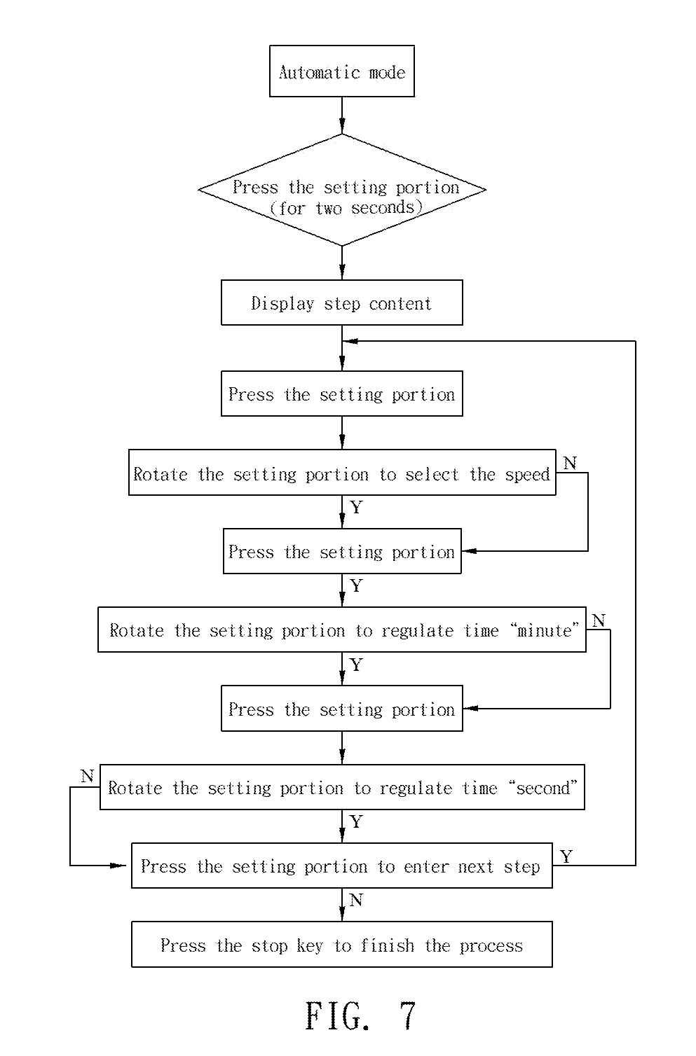

If stirring steps of pineapple bread needs to be set as shown in FIG. 7, the setting portion 20 is pressed for two seconds such that the display component 26 would display stirring steps as shown in FIG. 8. The screen displays individual stirring speed and stirring time with respect to step one to step five. The stirring speed in the embodiment indicates codes from one to six. Stirring speed of each code can be set according to user's demands. If the user would like to change the stirring time and the stirring speed of each step, the setting portion 20 is pressed and rotated to assigned stirring speed, and after pressing the setting portion 20 to confirm the stirring speed, the setting portion 20 can be rotated to select the stirring time. The setting portion 20 is further pressed to confirm that the change has been done. The embodiment comprises time parameters such as minutes and seconds. After completely changing the stirring time, the setting portion 20 is pressed to perform confirmation. The setting portion 20 then is further pressed to enter next step. Alternatively, the stop key 22 is pressed to finish the setting.

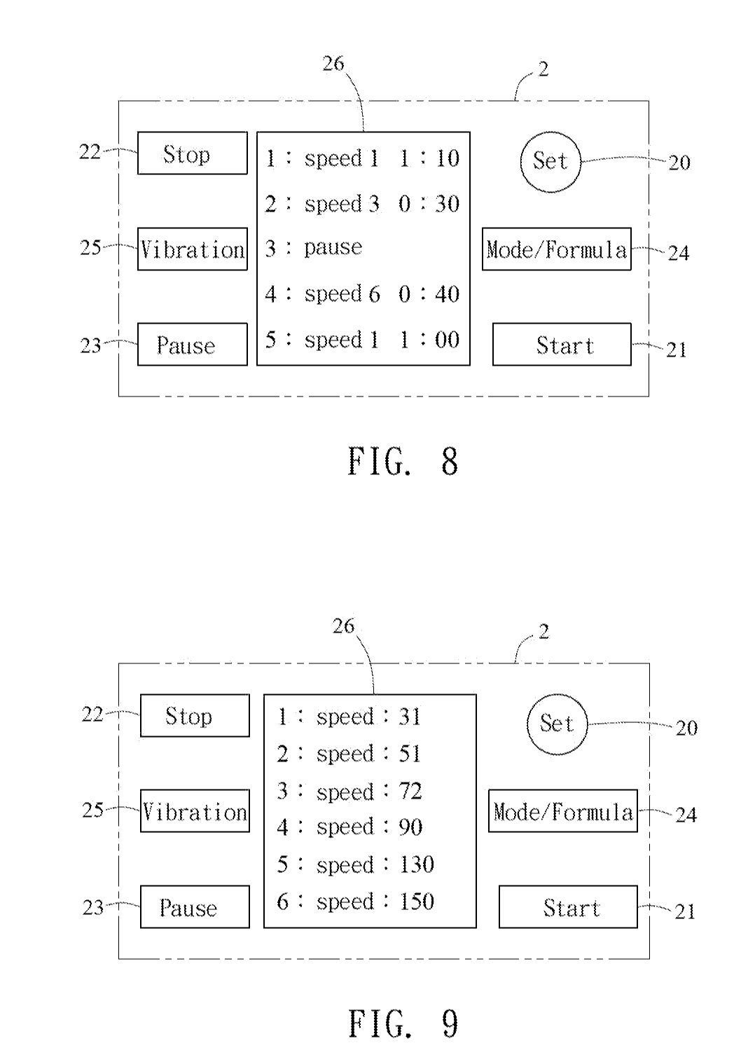

The setting of stirring speed in the embodiment is represented with codes. While setting the stirring speed of each code as shown in a setting page of FIG. 9, six codes in the embodiment are preset a set of public options. The stirring speed of each code can be changed through the pressing confirmation and rotation selection of the setting portion 20. While setting the stirring speed of sub-classes below each food material class of the embodiment, the stirring speeds set by predetermined six codes are selected. In another word, each sub-class in each stirring step can individually select any code within the six codes as a selected stirring speed. In addition, while setting the stirring speed of sub-classes below each food material class of the embodiment, it does not only take the predetermined six codes as public options to set the stirring speed, but also respectively sets the stirring step of each step in each sub-class. In other words, while setting the stirring step of each step, the stirring speeds of the six codes are not applied, and each sub-class has one set of independent option containing six codes. Each code also represents a stirring speed, and the stirring speed can be changed by utilizing the pressing confirmation and rotation selection of the setting portion 20 such that any code in each step shown in FIG. 8 is selected as a stirring speed to flexibly apply the selection of the stirring speed. Moreover, the stirring speed can be independently set in the stirring steps of each sub-class to exclude the setting page as shown in FIG. 9. In another word, in the setting page shown in FIG. 8, the code is directly replaced with numerical of the stirring speed to directly set the correspondingly stirring step in each step.

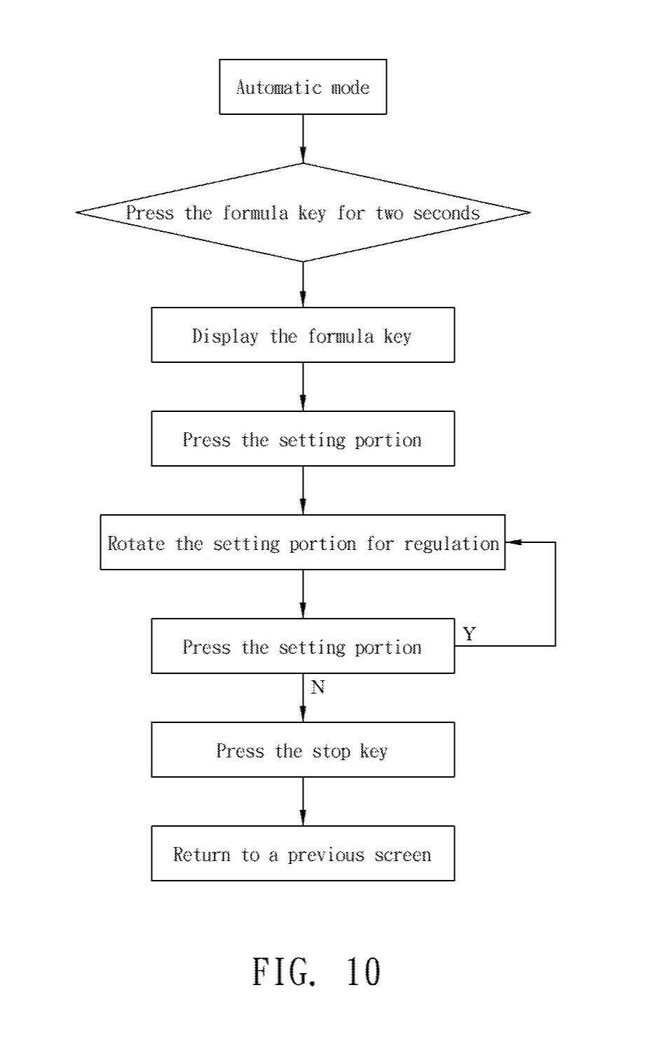

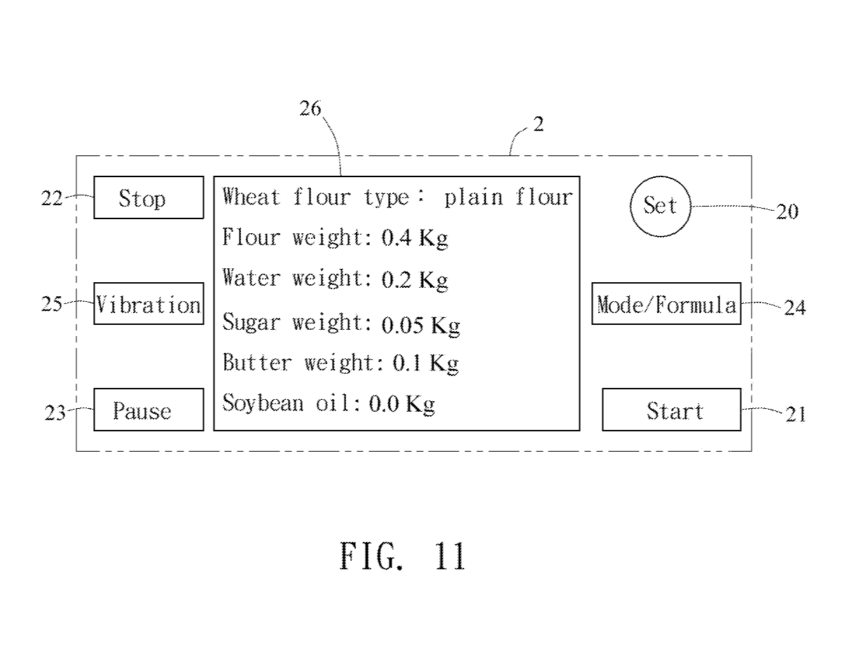

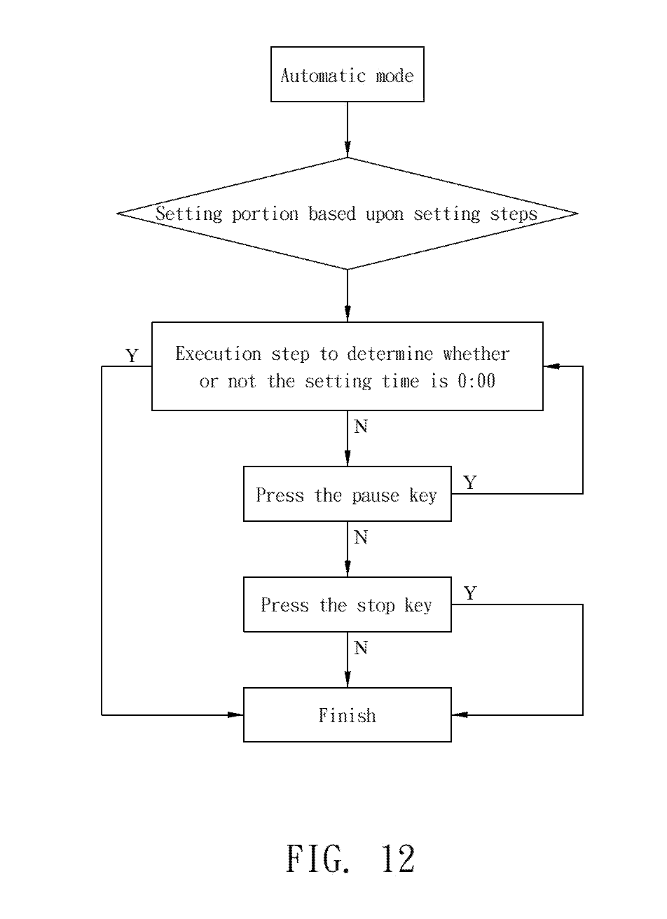

If the formula content of pineapple bread needs to be set, as shown in the setting flow of FIG. 10, the mode/formula key 24 is pressed for two seconds. The display component 26 then displays the formula content as shown in FIG. 11. The formula required for stirring pineapple bread is displayed. If the user would like to change formula content, the setting portion 20 is pressed and rotated to reach the assigned formula option, and after pressing the setting portion 20 for confirmation, parameters within the option can be regulated by rotating the setting portion 20. The stop key 22 can be pressed to finish the setting after completing the parameter confirmation by further pressing the setting portion 20.

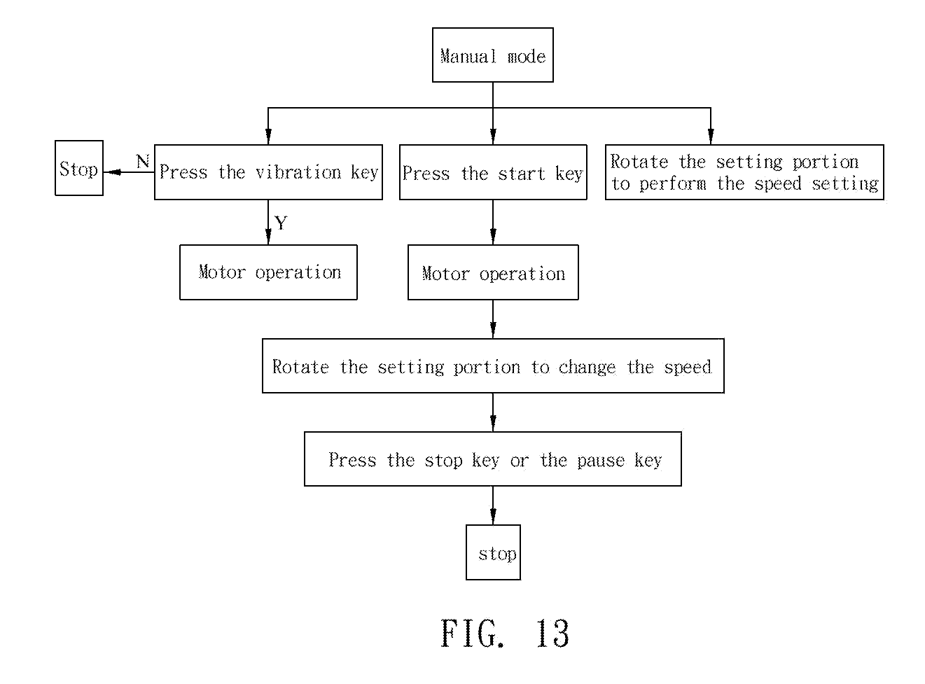

After completing the stirring setting of pineapple bread, the bread can be stirred at the automatic mode. As shown in FIG. 12, a flow of the automatic mode is depicted. After pressing the start key 21, the stirring process is performed according to the set stirring step. The pause key 23 can be pressed to suspend the stirring step during the stirring process, and steps, which are not completed yet, are continued by pressing the start key 21. In addition, the stop key 22 can be pressed during the stirring process. In the meantime the stirring step is finished. While pressing the start key 21, the stirring step is restarted. In the embodiment, when the stirring time is set as zero in one of stirring steps, the stirring step is finished through determination.

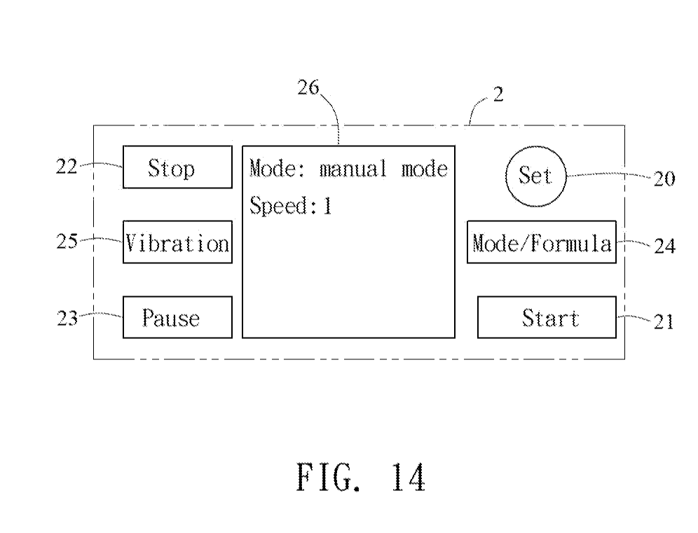

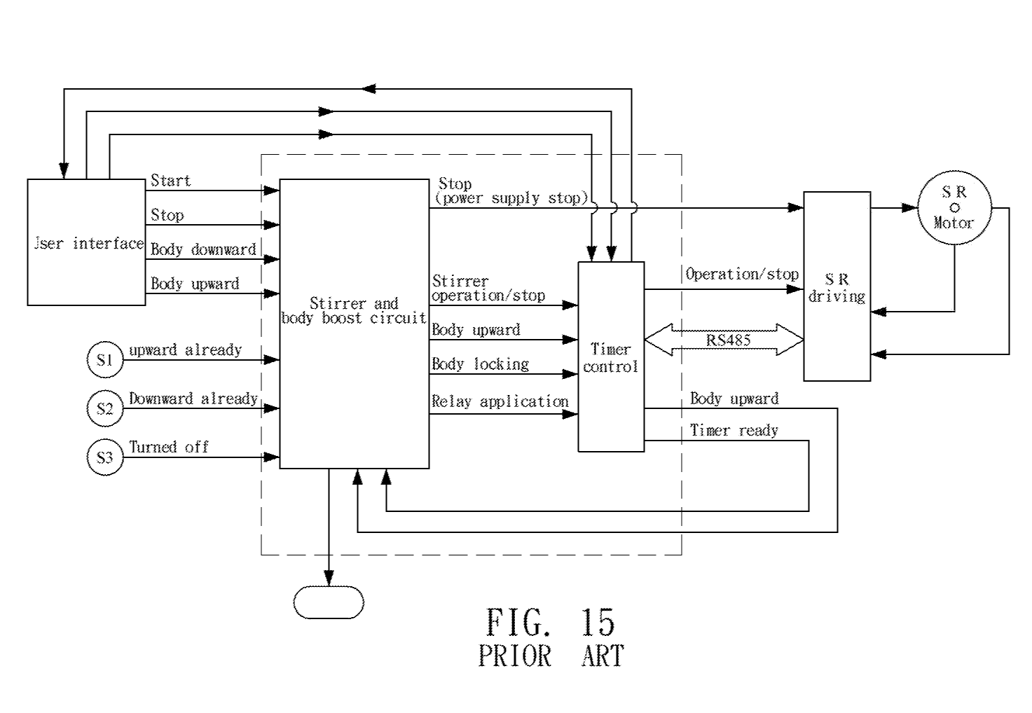

As shown in FIG. 13, a flow of the manual mode is depicted. While pressing the vibration key 25, the three-phase induction motor 15 is operated to allow the stirring axle to rotate and perform the revolution. When the stirring axle 16 moves to a proper position, the vibration key 25 is released to stop the three-phase induction motor 15. While pressing the start key 21, the three-phase induction motor 15 starts operation based upon the set stirring speed. While pressing the pause key 23 or the stop key 22, the operation of the three-phase induction motor 15 is finished. The stirring speed of the three-phase induction motor 15 can be set by pressing and rotating the setting portion 20. As shown in FIG. 14, the display component 26 provides the display screen at the manual mode and provides the set stirring speed.

The features of the invention are depicted as the following:

1. There is no need to dispose a coder or a motor rotating speed feedback meter between the three-phase induction motor 15 and the frequency changer of the stirrer according to the invention. Therefore, abnormal problems between the controller and the three-phase induction motor 15 resulted from the coder or the motor rotating speed feedback meter can be prevented. Wires between the controller and the three-phase induction motor 15 can be simplified by leaving out the coder or the motor rotating speed feedback meter.

2. The stirrer according to the invention utilizes the controller to save formula, stirring steps for different foods and save predetermined parameters such as stirring speeds and stirring time required for different stirring steps, and formula, the stirring steps and the predetermined parameters can be changed through the setting and updated into new parameters. Failure to stir food material caused by artificial mistakes can be reduced to increase the efficiency of the operation in stirring food materials.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

1. A stirrer having programmable stirring mode control comprising:
a stirrer main body having
a bottom seat,
a stand column vertically disposed on the bottom seat, the stand column having a top,
a head portion disposed horizontally on the top of the stand column, the head portion having a stirring axle downwardly stretched toward a stirring bucket,
two support arms outwardly stretched from the stand column to combine with the stirring bucket,
a driving mechanism, disposed in the head portion to drive the stirring axle to rotate and to simultaneously drive the stirring axle eccentrically circling a center of the stirring bucket, comprising a three-phase induction motor;
an input interface comprising a plurality of input components and at least one display component;
a controller for executing an execution program, in an automatic mode that comprises stirring steps of multiple sets of material items, each stirring step being defined according to a set of predetermined parameters, the predetermined parameters comprising stirring speeds and stirring times for each stirring step and each material item, the predetermined parameters being stored by the controller and displayed by the display component, the predetermined parameters can be updated with input received from an input component; and
a frequency changer, connected to and controlled by the controller, comprising a vector control circuit for controlling an induction motor,
wherein the controller executes the execution program in the automatic mode, the induction motor automatically changes stirring speeds periodically according to the material item selected.

2. The stirrer having programmable stirring mode control as recited in claim 1, wherein the plurality of input components of the input interface comprises a setting portion, a start key, a stop key and a pause key, and the setting portion being a flying shuttle knob having a pressing confirmation function.

3. The stirrer having programmable stirring mode control as recited in claim 2, wherein the execution program further comprises a manual mode, and the plurality of input components further comprise a mode key and a vibration key, and the execution program is switched between the automatic mode and the manual mode through the mode key, and while in the manual mode, the induction motor vibrates and operates when the vibration key is pressed, and the induction motor remains operational by pressing the start key, and the induction motor is stopped by pressing the pause key or the stop key, and when the induction motor starts or is at a stop state, the setting portion is rotated to directly change a speed of the three-phase induction motor.

4. The stirrer having programmable stirring mode control as recited in claim 2, wherein the setting portion is pressed to enter options for the material items, and the options are selected by rotating the setting portion, and a selected option is confirmed by pressing the setting portion.

5. The stirrer having programmable stirring mode control as recited in claim 2, wherein the setting portion is pressed for two seconds to enter a content setting of the stirring steps, and a predetermined parameter is selected by rotating the setting portion, and the setting portion is further pressed to enter options of the predetermined parameter, and numerical value of the predetermined parameter is regulated by rotating the setting portion, and the numerical value of the predetermined parameter is confirmed by pressing the setting portion, and the setting is finished by pressing the stop key.

6. The stirrer having programmable stirring mode control as recited in claim 5, wherein the predetermined parameter is a setting time, and when the setting time is set as zero, the execution program determines that the stirring step is finished.

7. The stirrer having programmable stirring mode control as recited in claim 2, wherein a setting of a formula content of a material item is further provided at the automatic mode, and the formula content is regulated by rotating the setting portion, and a selected option is confirmed by pressing the setting portion, and the setting is finished by pressing the stop key.

8. The stirrer having programmable stirring mode control as recited in claim 1, wherein the execution program provides a set of options having a plurality of stirring speeds, and the set of options is commonly selected by multiple sets of the material items, and the stirring speed of each option is set and changed by the plurality of input components, and each stirring step in each material item randomly selects one option as the stirring speed.

9. The stirrer having programmable stirring mode control as recited in claim 1, wherein the execution program provides a set of options having a plurality of stirring speeds to each material item respectively, and each set of options is independently selected with respect to the material item, and the stirring speed of each option is set and changed by the plurality of input components, and each stirring step in each material item randomly selects one option as the stirring speed.

10. The stirrer having programmable stirring mode control as recited in claim 8 or 9, wherein the stirring speed is represented by a code.
